(19) United States
(12) Patent Application Publication
(10) Pub. No.: US 2015/0210795 A1
(43) Pub. Date: Jul. 30, 2015

(54) AMPHIPHILIC CARBAMATE-FUNCTIONAL COPOLYMERS AND COATINGS CONTAINING THEM

(71) Applicant: BASF Coatings GmbH, Muenster (DE)

(72) Inventor: Sarav B. Jhaveri, Lincoln Park, MI (US)

(73) Assignee: BASF Coatings GmbH, Muenster (DE)

(21) Appl. No.: 14/168,495

(22) Filed: Jan. 30, 2014

(51) Int. Cl. C08F 220/18; C09D 133/14; C09D 133/10; C08F 220/28

(52) U.S. Cl. CPC C08F 220/18; C08F 220/28; C09D 133/14; C09D 133/10; C08F 2220/281; C08F 2220/1883; C08F 2220/1891; C08F 2220/1825

(57) ABSTRACT

A coating composition is made with (a) an amphiphilic carbamate-functional copolymer having from about 5 to about 75 weight percent of monomer units (i) with carbamate groups and from about 16 to about 70 weight percent of monomer units (ii) with C₈ to C₂₄ hydrocarbyl groups, with the proviso that the sum of the weight percent of monomer units (i) and the weight percent of monomer units (ii) is at least about 50 weight percent of the copolymer and (b) an aminoplast curing agent.

### FIELD OF THE INVENTION

The invention concerns thermosetting coating compositions, particularly automotive clearcoat compositions, containing carbamate-functional copolymers.

### BACKGROUND

This section provides information helpful in understanding the invention but that is not necessarily prior art.

Binder materials having carbamate groups have been used in thermosetting coating compositions, for instance in automotive clearcoat compositions. Such binder materials form cured coatings with excellent durability and weathering properties, resistance to scratching and marring, and resistance to etching from acid rain or other environmental agents. Among useful binder materials with carbamate groups are acrylic polymers (also known as poly(meth)acrylate polymers) having carbamate groups. Acrylic polymers have long been used in automotive coatings due to their ability to provide cured coatings with high gloss, clarity, and other desirable properties.

Another important consideration in formulating coatings, particularly those that will be applied via atomization, is the content of volatile organic compounds that may produce regulated emissions during the application process. While carbamate-functional resins may be cured with aminoplast resins, which are generally low viscosity, high solids crosslinkers, the carbamate resins themselves, especially carbamate-functional polymers, are generally rather high in viscosity. This is believed to be due to hydrogen bonding between the polar carbamate functional groups. Thus, while carbamate-functional acrylic polymers are beneficially used in coatings, especially automotive clearcoat coatings, the industry has struggled with the problem of reducing the content of volatile organics in such coatings without sacrificing performance.

### SUMMARY OF THE DISCLOSURE

Disclosed are certain carbamate-functional copolymers and coatings containing them. The carbamate-functional copolymers have (a) from about 5 to about 75 weight percent of monomer units with carbamate groups and (b) from about 15 to about 90 weight percent of monomer units with C₄ to C₂₄ hydrocarbyl groups, with the proviso that the sum of the weight percent of monomer units (a) and the weight percent of monomer units (b) is at least about 50 weight percent of the copolymer. Hydrocarbyl groups contain only hydrogen and carbon and are monovalent. As pertains to the technology now disclosed, the hydrocarbyl groups may be linear or branched but are free of cyclic groups. Carbamate-functional copolymers having these features are termed “amphiphilic” carbamate-functional copolymers. Carbamate groups may be represented by the structure

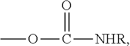

in which R is H or alkyl, preferably H or alkyl of 1 to 4 carbon atoms. Preferably R is H or methyl, and more preferably R is H.

The copolymers may be prepared with a nonvolatile content of from about 50 to 100 weight %, preferably from about 60 to about 85 weight %, as measured according to ASTM D2369. In various embodiments, the amphiphilic carbamate-functional copolymers have viscosities of no more than about 8000 cps, preferably viscosities of no more than about 6500 cps, even more preferably viscosities of from about 5000 cps to about 6000 cps as measured at 50° C. according to ASTM D7867 with the copolymer being in a 50 weight percent nonvolatile solution using a solvent mixture with a ratio of 42 wt % Aromatic 100 and 58 wt % dipropylene glycol monomethyl ether. A copolymer made in another solvent can be dried, then dissolved in the solvent mixture with a ratio of 42 wt % Aromatic 100 and 58 wt % dipropylene glycol monomethyl ether to 50 weight percent nonvolatiles determined according to ASTM D2369 to make a test sample for measuring the viscosity, which is then measured at 50° C. according to ASTM D7867.

In various embodiments, the disclosed coating composition includes the amphiphilic carbamate-functional acrylic copolymer and an aminoplast as a curing agent. In certain embodiments, the coating compositions are solventborne coatings in which the acrylic copolymers and aminoplast curing agents are dissolved in organic liquids (i.e., organic solvents). The carbamate-functional acrylic copolymers may particularly be used in preparing coating compositions for clearcoat layers or monocoat topcoat layers of automotive OEM finishes and refinishes. Cured coating layers produced from the coating compositions having a combination of high scratch resistance, good acid resistance, and good weathering stability. In various embodiments, the disclosed coating compositions are clearcoat compositions that are clear or transparent and either contain no pigments or contain only a low level of pigment, such as for tinting, that allow the coating layer produced from the coating composition to be transparent.

In various embodiments, the coating compositions contain weight ratios of the carbamate-functional acrylic copolymers to the aminoplast curing agent of from about 50:50 to about 85:15, preferably from about 60:40 to about 75:25. The coating composition may include other film-forming materials such as other thermosetting resins or polymers as well as other curing agents or crosslinkers for the amphiphilic carbamate-functional acrylic copolymer or for any such other thermosetting resins or polymers. The amphiphilic carbamate-functional acrylic copolymer may be from about 15 wt % to about 85 wt % based on total weight of film-forming materials (i.e., based on binder weight) in the coating composition.

The disclosed amphiphilic carbamate-functional acrylic copolymers have a reduced viscosity compared to carbamate-functional acrylic copolymers now in use, permitting a reduction of organic solvents in coatings into which they are incorporated. High solids solventborne topcoat (clearcoat or monocoat) coating compositions containing the amphiphilic carbamate-functional acrylic copolymers require less solvent to reach a viscosity suitable for spray application. It is also possible to incorporate higher amounts of carbamate functionality than could be done before while meeting requirements for low volatile organic content for the coating compositions, leading to cured coatings with higher crosslink densities and higher mechanical strength, durability, weatherability, and resistance to scratching and marring. In addition, the disclosed amphiphilic carbamate-functional copolymers provide comparatively better gloss and leveling for topcoats (clearcoats and monocoat topcoats) prepared using them.

For convenience, “resin” is used in this disclosure to encompass resin, oligomer, and polymer. “Binder” refers to the film-forming components (also called “vehicle”) of the coating composition. Thus, resins, crosslinkers, and other film-formers are part of the binder, but solvents, pigments, additives like antioxidants, HALS, UV absorbers, leveling agents, and the like that are not film formers are not part of the binder.

“A,” “an,” “the,” “at least one,” and “one or more” are used interchangeably to indicate that at least one of the item is present; a plurality of such items may be present unless the context clearly indicates otherwise. All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments. The terms “comprises,” “comprising,” “including,” and “having,” are inclusive and therefore specify the presence of stated items, but do not preclude the presence of other items. As used in this specification, using the term “or” includes each of the listed items individually and any and all combinations of two or more of the listed items. “Weight percent.” may be abbreviated to “wt %” or “wt. %” herein.

### DETAILED DESCRIPTION

A detailed description of exemplary, nonlimiting embodiments follows.

The amphiphilic carbamate-functional acrylic copolymers may be copolymers of any combination of acrylic monomer units, methacrylic monomer units, and monomer units from other copolymerizable vinyl monomers that result in a copolymer having (a) from about 5 to about 75 weight percent, preferably from about 20 to about 65 weight percent, and more preferably from about 40 to about 65 weight percent of monomer units with carbamate groups and (b) from about 16 to about 70 weight percent, preferably from about 25 to about 60 weight percent, and more preferably from about 30 to about 60 weight percent of monomer units with C₄ to C₂₄ hydrocarbyl groups, preferably C₈ to C₂₄ hydrocarbyl groups, with the proviso that the sum of the weight percent of monomer units (a) and the weight percent of monomer units (b) is at least about 50 weight percent, preferably at least about 60 weight percent, more preferably at least about 70 weight percent, and still more preferably at least about 80 weight percent of the copolymer. The term “(meth)acrylate” is used for convenience to designate either or both of acrylate and methacrylate, and the term “(meth)acrylic” is used for convenience to designate either or both of acrylic and methacrylic.

The amphiphilic carbamate-functional acrylic copolymers may be prepared by copolymerizing carbamate-functional ethylenically unsaturated monomers to provide monomer units (a). The amphiphilic carbamate-functional acrylic copolymers may also be prepared by reacting amphiphilic hydroxyl-functional acrylic copolymers having monomer units with hydroxyl groups and monomer units with C₄ to C₂₄ hydrocarbyl groups, preferably C₈ to C₂₄ hydrocarbyl groups, with a carbamate compound, particularly a lower alkyl carbamate like methyl carbamate, to substitute carbamate groups for the hydroxyl groups through what is referred to as “transcarbamation” or “transcarbamoylation.” Carbamate-functional ethylenically unsaturated monomers may be prepared by transcarbamating hydroxyl-functional monomers. Nonlimiting examples of suitable hydroxyl-functional monomers to transcarbamate to prepare carbamate-functional, ethylenically unsaturated monomers or to copolymerize to prepare a hydroxyl-functional acrylic copolymer for transcarbamation after polymerization include hydroxyalkyl esters of acrylic or methacrylic acid such as hydroxyethyl (meth)acrylate, hydroxypropyl (meth)acrylates, hydroxybutyl (meth)acrylates, hydroxyhexyl (meth)acrylates, propylene glycol mono(meth)acrylate, 2,3-dihydroxypropyl (meth)acrylate, pentaerythritol mono(meth)acrylate, polypropylene glycol mono(meth)acrylates, polyethylene glycol mono(meth)acrylates, reaction products of any of these with ε-caprolactone, other hydroxyalkyl (meth)acrylates having branched or linear hydroxyalkyl groups of up to about 10 carbons, and combinations of these. These may be transcarbamated before, during, or following polymerization. The person skilled in the art will appreciate that hydroxyl groups on an acrylic polymer can be generated by other means, such as, for example, the ring opening of a glycidyl group, for example provided from copolymerized glycidyl methacrylate, with an organic acid or an amine, or by hydrolysis of a ester, for example by hydrolysis of vinyl acetate monomer units to vinyl alcohol monomer units. Hydroxyl functionality may also be introduced through use of thio-alcohol compounds, including, without limitation, 3-mercapto-1-propanol, 3-mercapto-2-butanol, 11-mercapto-1-undecanol, 1-mercapto-2-propanol, 2-mercaptoethanol, 6-mercapto-1-hexanol, 2-mercaptobenzyl alcohol, 3-mercapto-1,2-proanediol, 4-mercapto-1-butanol, and combinations of these. This could be used in combination with polymerizing a hydroxyl-functional monomer. Any of these methods may be used to prepare a useful hydroxyl-functional copolymer for transcarbamation in preparing the amphiphilic carbamate-functional acrylic copolymers.

In various embodiments, at least a portion, and up to all, of the monomer units (a) with carbamate groups are methacrylate monomer units.

The monomer units (b) with C₄ to C₂₄ hydrocarbyl groups may be provided by copolymerization of (meth)acrylate monomers having C₄ to C₂₄ hydrocarbyl groups. Nonlimiting examples of these include n-butyl (meth)acrylate, hexyl (meth)acrylate, 2-ethylhexyl (meth)acrylate, 2-propylheptyl (meth)acrylate, isodecyl (meth)acrylate, lauryl (meth)acrylate, isotridecyl (meth)acrylate, hexadecyl (meth)acrylate, stearyl (meth)acrylate, eicosyl (meth)acrylate, behenyl (meth)acrylate, and so on, which may be used in any combination. For example, lauryl methacrylate may be used in combination with myristyl (meth)acrylate and cetyl (meth)acrylate.

In various embodiments, at least a portion, and up to all, of the monomer units (b) with C₄ to C₂₄ hydrocarbyl groups are methacrylate monomer units. In certain preferred embodiments, monomer units (b) with C₈ to C₂₄ hydrocarbyl groups are used.

Examples of suitable comonomers that may be polymerized with monomer units (a) and (b) include, without limitation, α,β-ethylenically unsaturated monocarboxylic acids containing 3 to 5 carbon atoms such as acrylic, methacrylic, and crotonic acids and their alkyl (other than those with C₄ to C₂₄ hydrocarbyl groups) and cycloalkyl esters, nitriles, and amides of acrylic acid, methacrylic acid, and crotonic acid; α,β-ethylenically unsaturated dicarboxylic acids containing 4 to 6 carbon atoms and the anhydrides, monoesters, and diesters of those acids; vinyl esters, vinyl ethers, vinyl ketones, and aromatic or heterocyclic aliphatic vinyl compounds. Representative examples of suitable comonomer esters of acrylic, methacrylic, and crotonic acids include, without limitation, methyl, ethyl, propyl, isopropyl esters and cyclic esters such as cyclohexyl, alkyl-substituted cyclohexyl, alkanol-substituted cyclohexyl, such as 2-tert-butyl and 4-tert-butyl cyclohexyl, 4-cyclohexyl-1-butyl, 2-tert-butyl cyclohexyl, 4-tert-butyl cyclohexyl, 3,3,5,5,-tetramethyl cyclohexyl, tetrahydrofurfuryl, and isobornyl acrylates, methacrylates, and crotonates; unsaturated dialkanoic acids and anhydrides such as fumaric, maleic, itaconic acids and anhydrides and their mono- and diesters with alcohols such as methanol, ethanol, propanol, isopropanol, butanol, isobutanol, and tert-butanol, such as maleic anhydride, maleic acid dimethyl ester and maleic acid monohexyl ester; vinyl acetate, vinyl propionate, vinyl ethyl ether, and vinyl ethyl ketone; styrene, α-methyl styrene, vinyl toluene, 2-vinyl pyrrolidone, and p-tert-butylstyrene.

The acrylic polymer may be prepared using conventional techniques, such as by heating the monomers in the presence of a polymerization initiating agent and optionally a chain transfer agent. The polymerization may be carried out in solution, for example.

Typical initiators are organic peroxides such as dialkyl peroxides such as di-t-butyl peroxide, peroxyesters such as t-butyl peroxy 2-ethylhexanoate, and t-butyl peracetate, peroxydicarbonates, diacyl peroxides, hydroperoxides such as t-butyl hydroperoxide, and peroxyketals; azo compounds such as 2,2′azobis(2-methylbutanenitrile) and 1,1′-azobis(cyclohexanecarbonitrile); and combinations of these. Typical chain transfer agents are mercaptans such as octyl mercaptan, n- or tert-dodecyl mercaptan; halogenated compounds, thiosalicylic acid, mercaptoacetic acid, mercaptoethanol and the other thiol alcohols already mentioned, and dimeric α-methyl styrene.

The reaction is usually carried out at temperatures from about 20° C. to about 200° C. The reaction may conveniently be done at a reflux temperature, although with proper control a temperature below the reflux may be maintained. The initiator should be chosen to match the temperature at which the reaction is carried out, so that the half-life of the initiator at that temperature should preferably be no more than about thirty minutes, preferably no more than about ten minutes. Further details of addition polymerization generally and of polymerization of mixtures including (meth)acrylate monomers is readily available in the polymer art. The solvent or solvent mixture is generally heated to the reaction temperature and the monomers and initiator(s) are added at a controlled rate over a period of time, usually between 2 and 6 hours. A chain transfer agent or additional solvent may be fed in also at a controlled rate during this time. The temperature of the mixture is then maintained for a period of time to complete the reaction. Optionally, additional initiator may be added after the monomer feed is completed to ensure complete conversion.

When the product copolymer is hydroxyl-functional, the copolymer is transcarbamated with a carbamate compound. The carbamate compound may be methyl or ethyl carbamate, in which the carbamate group has a structure

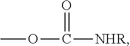

in which R is H or alkyl, preferably H or alkyl of 1 to 4 carbon atoms. Preferably R is H or methyl, and more preferably R is H.

The transcarbamation reaction may be carried out using a suitable catalyst, nonlimiting examples of which include tin compounds such as dibutyl tin oxide and dibutyl tin dilaurate, Bi(III) compounds such as bismuth (III) oxide and bismuth (III) tri(2-ethylhexanoate), and Zr(IV) compounds such as zirconium alkoxides, zirconium alkanoates, and zirconium dihalide oxides.

The transcarbamation is preferably carried out in the absence of oxygen, for example under a nitrogen atmosphere. The nitrogen blanket may be removed as the temperature begins to approach reflux as long as the nitrogen is resumed once reflex is lost. The reaction vessel is equipped with suitable stirring, heating and cooling equipment as well as with a reflux condenser which condenses volatile constituents, for example solvent and alcohol by-product from the transcarbamation reaction. A trap or some other device may also be included for removing the alcohol by-product. The transcarbamation reaction may be carried out at a temperature in the range of from 100° C. to about 160° C., preferably from about 120° C. to about 150° C.

The progress of the transcarbamation reaction may be followed by monitoring hydroxyl number of the hydroxyl-functional material or by monitoring the amount of by-product alcohol collected.

The polymerization and transcarbamation reactions are carried out in an organic solvent or mixture of organic solvents that is inert toward the monomers used. Examples of suitable solvents include aromatic hydrocarbons, for example toluene, xylene, mesitylene, 2-, 3-, or 4-ethyltoluene, naphthas, as well as higher-boiling aliphatic and cycloaliphatic hydrocarbons, for example various white spirits, mineral turpentine, tetralin and decalin, and also ketones, individually or as mixtures.

It is possible to react the carbamate compound with hydroxyl groups in the presence of a suitable catalyst, for example one of those mentioned above, during preparation of a resin or during polymerization of the acrylic copolymer. The carbamate compound and the transcarbamation catalyst can be introduced into the reactor before or with the hydroxyl monomer. This allows part or all of the transcarbamation to be completed by the time the initial monomer conversion is finished. The carbamate compounds and transcarbamation catalyst could also be introduced at any point during the time the monomer mixture is introduced into the reactor or after all of the monomers have been introduced into the reactor.

The amphiphilic carbamate-functional acrylic copolymers may preferably have weight average molecular weights of from about 1000 to about 20,000, preferably from about 1500 to about 10,000. The amphiphilic carbamate-functional acrylic copolymers may have number average molecular weights of from about 500 to about 15,000, preferably from about 1000 to about 8000. The amphiphilic carbamate-functional acrylic copolymers may preferably have theoretical glass transition temperatures of from about −80° C. to about +100° C., preferably from about −45° C. to about 20° C., as calculated using the Fox Equation in which the reciprocal of the glass transition temperature (in degrees Kelvin) of the copolymer is the summation for all different copolymerized monomers of the reciprocal of the glass transition temperature (in degrees Kelvin) for a homopolymer of each monomer multiplied by the weight fraction of that monomer in the copolymer (see T. G. Fox, Bull. Am. Phys. Soc. 1 (1956)) 123).

The copolymers are prepared with a nonvolatile content of from about 50 to 100 weight %, preferably from about 60 to about 85 weight %, as measured according to ASTM D2369. In various embodiments, the amphiphilic carbamate-functional copolymers have viscosities of no more than about 8000 cps, preferably viscosities of no more than about 6500 cps, even more preferably viscosities of from about 5000 cps to about 6000 cps at 50° C. as measured according to ASTM D7867 with the copolymer being in a 50 weight percent nonvolatile solution using a solvent mixture with a ratio of 42 wt % Aromatic 100 and 58 wt % dipropylene glycol monomethyl ether. A copolymer made in another solvent can be dried, then dissolved in the solvent mixture with a ratio of 42 wt % Aromatic 100 and 58 wt % dipropylene glycol monomethyl ether to 50 weight percent nonvolatiles determined according to ASTM D2369 to make a test sample for measuring the viscosity, which is then measured at 50° C. according to ASTM D7867.

### Coating Compositions

The amphiphilic carbamate-functional acrylic copolymers may be formulated into curable coating compositions. The amphiphilic carbamate-functional acrylic copolymer may be from about 15 wt % to about 85 wt % based on total weight of film-forming materials (i.e., based on binder weight) in the coating composition. The film-forming materials in the coating composition other than the amphiphilic carbamate-functional acrylic copolymer may include other thermosetting resins or polymers as well as curing agents or crosslinkers for the amphiphilic carbamate-functional acrylic copolymer and for any such other thermosetting resins or polymers.

The coating composition may be cured by a reaction of the amphiphilic carbamate-functional acrylic copolymer with a curing agent that is a compound having a plurality of functional groups that are reactive with the carbamate groups on the polymer. Such reactive groups include active methylol, methylalkoxy or butylalkoxy groups on aminoplast resins. Amiriopiasts, or amino resins, are described in Encyclopedia of Polymer Science and Technology vol. 1, p. 752-789 (1985), the disclosure of which is hereby incorporated by reference. An aminoplast may be obtained by reaction of an activated nitrogen with a lower molecular weight aldehyde, optionally with further reaction with an alcohol (preferably a mono-alcohol with one to four carbon atoms such as methanol, isopropanol, n-butanol, isobutanol, etc.) to form an ether group. Preferred examples of activated nitrogens are activated amines such as melamine, benzoguanamine, cyclohexylcarboguanamine, and acetoguanamine; ureas, including urea itself, thiourea, ethyleneurea, dihydroxyethyleneurea, and guanylurea; glycoluril; amides, such as dicyandiamide; and carbamate functional compounds having at least one primary carbamate group or at least two secondary carbamate groups. The activated nitrogen is reacted with a lower molecular weight aldehyde. The aldehyde may be selected from formaldehyde, acetaldehyde, crotonaldehyde, benzaldehyde, or other aldehydes used in making aminoplast resins, although formaldehyde and acetaldehyde, especially formaldehyde, are preferred. The activated nitrogen groups are at least partially alkylolated with the aldehyde, and may be fully alkylolated; preferably the activated nitrogen groups are fully alkylolated. The reaction may be catalyzed by an acid, e.g. as taught in U.S. Pat. No. 3,082,180, the contents of which are incorporated herein by reference.

The optional alkylol groups formed by the reaction of the activated nitrogen with aldehyde may be partially or fully etherified with one or more monofunctional alcohols. Suitable examples of the monofunctional alcohols include, without limitation, methanol, ethanol, n-propanol, isopropanol, n-butanol, isobutanol, tert-butyl alcohol, benzyl alcohol, and so on. Monofunctional alcohols having one to four carbon atoms and mixtures of these are preferred. The etherification may be carried out, for example, by the processes disclosed in U.S. Pat. Nos. 4,105,708 and 4,293,692, the disclosures of which are incorporated herein by reference. The aminoplast may be at least partially etherified, and in various embodiments the aminoplast is fully etherified. For example, the aminoplast compounds may have a plurality of methylol and/or etherified methylol, butylol, or alkylol groups, which may be present in any combination and along with unsubstituted nitrogen hydrogens. Examples of suitable curing agent compounds include, without limitation, melamine formaldehyde resins, including monomeric or polymeric melamine resins and partially or fully alkylated melamine resins, and urea resins (e.g., methylol ureas such as urea formaldehyde resin, and alkoxy ureas such as butylated urea formaldehyde resin). One nonlimiting example of a fully etherified melamine-formaldehyde resin is hexamethoxymethyl melamine.

The alkylol groups are capable of self reaction to form oligomeric and polymeric materials. Useful materials are characterized by a degree of polymerization. For melamine formaldehyde resins, it is preferred to use resins having a number average molecular weight less than about 2000, more preferably less than 1500, and even more preferably less than 1000.

A coating composition including the amphiphilic carbamate-functional acrylic copolymers and aminoplast crosslinking agents may further include a strong acid catalyst to enhance the cure reaction. Such catalysts are well-known in the art and include, for example, para-toluenesulfonic acid, dinonylnaphthalene disulfonic acid, dodecylbenzenesulfonic acid, phenyl acid phosphate, monobutyl maleate, butyl phosphate, and hydroxy phosphate ester. Strong acid catalysts are often blocked, e.g. with an amine.

The amount of the amphiphilic carbamate-functional acrylic copolymer and the aminoplast crosslinker in the coating composition may be varied widely. In various preferred embodiments, the coating compositions contain weight ratios of the carbamate-functional acrylic copolymers to the aminoplast curing agent of from about 50:50 to about 85:15, preferably from about 60:40 to about 75:25.

Other thermosetting resins or polymers that may also be used in making the coating compositions is not particularly limited. When the coating composition is for a clearcoat, basecoat, or monocoat topcoat for automotive applications, suitable other thermosetting resins or polymers include other carbamate-functional resins and polymers and hydroxyl-functional resins and polymers, including copolymers of (meth)acrylate monomers, polyurethanes, and polyesters.

A solvent may be utilized in the coating compositions. In general, the solvent can be any organic solvent or combination of organic solvents. In one preferred embodiment, the solvent is or includes a polar organic solvent. More preferably, the solvent is or includes a polar aliphatic solvent or polar aromatic solvent. Still more preferably, the solvent is or includes on or more of ketone, ester, acetate, aprotic amide, aprotic sulfoxide, and aprotic amine solvents. Examples of specific useful solvents include methyl ethyl ketone, methyl isobutyl ketone, n-amyl acetate, ethylene glycol butyl ether acetate, propylene glycol monomethyl ether acetate, xylene, N-methylpyrrolidone, and blends of aromatic hydrocarbons, which may be used in combination. In another preferred embodiment, the amphiphilic carbamate-functional acrylic copolymer and aminoplast crosslinker are dispersed in water or a mixture of water with small amounts of organic water-soluble or -miscible co-solvents. The amphiphilic carbamate-functional acrylic copolymers may be dispersed in water by, for example, at least partially neutralizing carboxylic acid groups of the copolymers with ammonia or an amine. The solvent present in the coating composition is preferably in an amount of from about 0.01 weight percent to about 99 weight percent, preferably from about 10 weight percent to about 60 weight percent, and more preferably from about 30 weight percent to about 50 weight percent. The solvent or solvent mixture may be composed of aromatic hydrocarbons such as 1,2,4-trimethylbenzene, mesitylene, xylene, propylbenzene and isopropylbenzene. One example of a suitable solvent mixture comprising aromatic hydrocarbons is solvent naphtha. The solvent may also be composed of aliphatic hydrocarbons, ketones such as acetone, methyl ethyl ketone or methyl amyl ketone, esters such as ethyl acetate, butyl acetate, pentyl acetate or ethyl ethoxy propionate, ethers or mixtures of the aforementioned solvents. Examples of such solvents are aliphatic and/or aromatic hydrocarbons such as toluene, xylene, solvent naphtha, and mineral spirits, ketones, such as acetone, methyl ethyl ketone or methyl amyl ketone, esters, such as ethyl acetate, butyl acetate, pentyl acetate or ethyl ethoxypropionate, ethers such as glycol ethers like propylene glycol monomethyl ether, alcohols such as ethanol, propanol, isopropanol, n-butanol, isobutanol, and tert-butanol, nitrogen-containing compounds such as N-methyl pyrrolidone and N-ethyl pyrrolidone, and combinations of these.

When the coating compositions are formulated as monocoat topcoats, they contain pigments and fillers, including special effect pigments. Nonlimiting examples of special effect pigments that may be utilized in basecoat and monocoat topcoat coating compositions include metallic, pearlescent, and color-variable effect flake pigments. Metallic (including pearlescent, and color-variable) topcoat colors are produced using one or more special flake pigments. Metallic colors are generally defined as colors having gonioapparent effects. For example, the American Society of Testing Methods (ASTM) document F284 defines metallic as “pertaining to the appearance of a gonioapparent material containing metal flake.” Metallic basecoat colors may be produced using metallic flake pigments like aluminum flake pigments, coated aluminum flake pigments, copper flake pigments, zinc flake pigments, stainless steel flake pigments, and bronze flake pigments and/or using pearlescent flake pigments including treated micas like titanium dioxide-coated mica pigments and iron oxide-coated mica pigments to give the coatings a different appearance (degree of reflectance or color) when viewed at different angles. Metal flakes may be cornflake type, lenticular, or circulation-resistant; micas may be natural, synthetic, or aluminum-oxide type. The flake pigments are typically satisfactorily dispersed in a binder component by stirring under low shear. The flake pigment or pigments may be included in the high solids coating composition in an amount of about 0.01 wt. % to about 0.3 wt. % or about 0.1 wt. % to about 0.2 wt. %, in each case based on total binder weight. Nonlimiting examples of commercial flake pigments include PALIOCROME® pigments, available from BASF Corporation.

Nonlimiting examples of other suitable pigments and fillers that may be utilized in basecoat and monocoat topcoat coating compositions include inorganic pigments such as titanium dioxide, barium sulfate, carbon black, ocher, sienna, umber, hematite, limonite, red iron oxide, transparent red iron oxide, black iron oxide, brown iron oxide, chromium oxide green, strontium chromate, zinc phosphate, silicas such as fumed silica, calcium carbonate, talc, barytes, ferric ammonium ferrocyanide (Prussian blue), and ultramarine, and organic pigments such as metallized and non-metallized azo reds, quinacridone reds and violets, perylene reds, copper phthalocyanine blues and greens, carbazole violet, monoarylide and diarylide yellows, benzimidazolone yellows, tolyl orange, naphthol orange, nanoparticles based on silicon dioxide, aluminum oxide, zirconium oxide, and so on. The pigment(s) and any filler(s) are preferably dispersed in a resin or polymer or with a pigment dispersant, such as binder resins of the kind already described, according to known methods. In general, the pigment and dispersing resin, polymer, or dispersant are brought into contact under a shear high enough to break the pigment agglomerates down to the primary pigment particles and to wet the surface of the pigment particles with the dispersing resin, polymer, or dispersant. The breaking of the agglomerates and wetting of the primary pigment particles are important for pigment stability and color development. Pigments and fillers may be utilized in amounts typically of up to about 60% by weight, based on total weight of the coating composition. The amount of pigment used depends on the nature of the pigment and on the depth of the color and/or the intensity of the effect it is intended to produce, and also by the dispersibility of the pigments in the pigmented coating composition. The pigment content, based in each case on the total weight of the pigmented coating composition, is preferably 0.5% to 50%, more preferably 1% to 30%, very preferably 2% to 20%, and more particularly 2.5% to 10% by weight.

Clearcoat coating compositions typically include no pigment, but may include small amount of colorants or fillers that do not unduly affect the transparency or desired clarity of the clearcoat coating layer produced from the composition.

Additional customary coating additives agents may be included, for example, surfactants, stabilizers, wetting agents, dispersing agents, adhesion promoters, UV absorbers, hindered amine light stabilizers such as HALS compounds, benzotriazoles or oxalanilides; free-radical scavengers; slip additives; defoamers; reactive diluents, of the kind which are common knowledge from the prior art; wetting agents such as siloxanes, fluorine compounds, carboxylic monoesters, phosphoric esters, polyacrylates, for example polybutyl acrylate, or polyurethanes; adhesion promoters such as tricyclodecanedimethanol; flow control agents; film-forming assistants such as cellulose derivatives; rheology control additives, such as the additives known from patents WO 94/22968, EP-A-0 276 501, EP-A-0 249 201 or WO 97/12945; crosslinked polymeric microparticles, as disclosed for example in EP-A-0 008 127; inorganic phyllosilicates such as aluminum-magnesium silicates, sodium-magnesium and sodium-magnesium-fluorine-lithium phyllosilicates of the montmorillonite type; silicas such as Aerosils®; or synthetic polymers containing ionic and/or associative groups such as polyvinyl alcohol, poly(meth)acrylamide, poly(meth)acrylic acid, polyvinylpyrrolidone, styrene-maleic anhydride copolymers or ethylene-maleic anhydride copolymers and their derivatives, or hydrophobically modified ethoxylated urethanes or polyacrylates; flame retardant; and so on. Typical coating composition include one or a combination of such additives.

Coating compositions can be coated onto a substrate by any of a number of techniques well-known in the art. These include, for example, spray coating, dip coating, roll coating, curtain coating, and the like. For automotive body panels, spray coating is preferred. The coating compositions of the invention can be applied by any of the typical application methods, such as spraying, knife coating, spreading, pouring, dipping, impregnating, trickling or rolling, for example. In the course of such application, the substrate to be coated may itself be at rest, with the application equipment or unit being moved. Alternatively the substrate to be coated, in particular a coil, may be moved, with the application unit at rest relative to the substrate or being moved appropriately. For automotive topcoats (including clearcoats), reference is given to employing spray application methods, such as compressed-air spraying, airless spraying, high-speed rotation, electrostatic spray application, alone or in conjunction with hot spray application such as hot-air spraying, for example.

The coating compositions and coating systems of the invention, especially the clearcoat compositions, are employed in particular in the technologically and esthetically particularly demanding field of automotive OEM finishing and also of automotive refinish. With particular preference the coating compositions of the invention are used in multistage coating methods, particularly in methods where a pigmented basecoat film is first applied to an uncoated or precoated substrate and then a layer of the coating composition with the amphiphilic carbamate-functional copolymer is applied, providing a multicoat effect or color coating system with at least one pigmented basecoat and at least one clearcoat over the basecoat.

When the coating composition is used as the clearcoat of a composite basecoat-plus-clear coating, the pigmented basecoat composition may be a coating composition containing the disclosed amphiphilic carbamate-functional copolymer or may be any of a number of types well-known in the art, and does not require detailed explanation in detail herein. Polymers known in the art to be useful in basecoat compositions include acrylic polymers, polyvinyl polymers, polyurethanes, polycarbonates, polyesters, alkyds, and polysiloxanes. Preferred polymers include acrylic polymers and polyurethanes. In one preferred embodiment of the invention, the basecoat composition also utilizes a carbamate-functional acrylic polymer. Basecoat polymers may be thermoplastic, but are preferably crosslinkable and comprise one or more type of crosslinkable functional groups. Such groups include, for example, hydroxy, isocyanate, amine, epoxy, acrylate, vinyl, silane, and acetoacetate groups. These groups may be masked or blocked in such a way so that they are unblocked and available for the crosslinking reaction under the desired curing conditions, generally elevated temperatures. Basecoat polymers may be self-crosslinkable or may require a separate crosslinking agent that is reactive with the functional groups of the polymer. When the polymer comprises hydroxy functional groups, for example, the crosslinking agent may be an aminoplast resin, isocyanate and blocked isocyanates (including isocyanurates), and acid or anhydride functional crosslinking agents. The basecoats contain one or more of the pigments and optionally the fillers already mentioned.

Both water-thinnable basecoat coating compositions and basecoat coating compositions based on organic solvents can be used. The applied basecoat coating composition is preferably first dried, i.e., at least some of the organic solvent or water is stripped from the basecoat film in an evaporation phase. Drying is accomplished preferably at temperatures from room temperature to 80° C. Drying is followed by the application of the coating composition containing the amphiphilic carbamate-functional copolymer.

The applied coating compositions can be cured after a certain rest time or “flash” period. The rest time serves, for example, for the leveling and devolatilization of the coating films or for the evaporation of volatile constituents such as solvents. The rest time may be assisted or shortened by the application of elevated temperatures or by a reduced humidity, provided this does not entail any damage or alteration to the coating films, such as premature complete crosslinking, for instance. The thermal curing of the coating compositions has no peculiarities in terms of method but instead takes place in accordance with the typical, known methods such as heating in a forced-air oven or irradiation with IR lamps. The thermal cure may also take place in stages. Another preferred curing method is that of curing with near infrared (NIR) radiation. Although various methods of curing may be used, heat-curing is preferred. Generally, heat curing is effected by exposing the coated article to elevated temperatures provided primarily by radiative heat sources. The thermal cure takes place advantageously at a temperature of 30 to 200° C., more preferably 40 to 190° C., and in particular for OEM coatings 50 to 180° C. for a time of 1 minute up to 10 hours, more preferably 2 minutes up to 5 hours, and in particular 3 minutes to 3 hours, although longer cure times may be employed in the case of the temperatures that are employed for automotive refinish, which are preferably cured at temperatures between 30 and 90° C. Curing temperatures for OEM coatings will vary depending on the particular crosslinking agents, however they generally range between 93° C. and 177° C., preferably between 115° C. and 150° C., and more preferably at temperatures between 115° and 138° C. for a blocked acid catalyzed system. For an unblocked acid catalyzed system, the cure temperature is preferably between 82° C. and 125° C. The curing time may vary depending on the particular components used, and physical parameters such as the thickness of the layers, however, typical curing times range from about 15 to about 60 minutes, and preferably about 15-25 minutes for blocked acid catalyzed systems and about 10-20 minutes for unblocked acid catalyzed systems.

The cured basecoat layers formed may have a thickness of from about 5 μm to about 75 μm, depending mainly upon the color desired and the thickness needed to form a continuous layer that will provide the color. The cured clearcoat layers formed typically have thicknesses of from about 30 μm to about 65 μm. The cured monocoat topcoat layers formed typically have thicknesses of from about 30 μm to about 80 μm.

The coating composition can be applied onto many different types of substrates, including metal substrates such as bare steel, phosphated steel, galvanized steel, or aluminum; and non-metallic substrates, such as plastics and composites. The substrate may also be any of these materials having upon it already a layer of another coating, such as a layer of an electrodeposited primer, primer surfacer, and/or basecoat, cured or uncured.

The substrate may be first primed with an electrodeposition (electrocoat) primer. The electrodeposition composition can be any electrodeposition composition used in automotive vehicle coating operations. Non-limiting examples of electrocoat compositions include the CATHOGUARD® electrocoating compositions sold by BASF. Electrodeposition coating baths usually comprise an aqueous dispersion or emulsion including a principal film-forming epoxy resin having ionic stabilization (e.g., salted amine groups) in water or a mixture of water and organic cosolvent. Emulsified with the principal film-forming resin is a crosslinking agent that can react with functional groups on the principal resin under appropriate conditions, such as with the application of heat, and so cure the coating. Suitable examples of crosslinking agents, include, without limitation, blocked polyisocyanates. The electrodeposition coating compositions usually include one or more pigments, catalysts, plasticizers, coalescing aids, antifoaming aids, flow control agents, wetting agents, surfactants, UV absorbers, HALS compounds, antioxidants, and other additives.

The electrodeposition coating composition is preferably applied to a dry film thickness of 10 to 35 μm. After application, the coated vehicle body is removed from the bath and rinsed with deionized water. The coating may be cured under appropriate conditions, for example by baking at from about 135° C. to about 190° C. for between about 15 and about 60 minutes.

The following examples illustrate the disclosed technology. All parts are parts by weight unless otherwise noted.

### EXAMPLES

### Example 1 of the Invention

### Amphiphilic Carbamate-Functional Copolymer

In a three-neck, round-bottom flask equipped with stirrer, heating mantle, and a reflux column including a partial condenser and a reflux condenser connected to a Dean-Stark trap, methyl carbamate (79.84 g) and Aromatic 100 solvent (240.50 g, Solvesso™ 100 from ExxonMobil) were heated to 140° C. under nitrogen. A mixture of 2-hydroxyethyl methacrylate (478.97 g), lauryl methacryiate (478.97 g, LMA 1214 from BASF Corporation), 2,2′-azobis(2-methylpropionitrile) (95.95 g), and Aromatic 100 solvent (39.60 g, Solvesso™ 100 from ExxonMobil) was fed from a monomer tank into the flask over 2.5 hours while maintaining the temperature of the reaction at 140° C. The monomer tank was flushed with Aromatic 100 solvent (39.60 g, Solvesso™ 100 from ExxonMobil). A small sample was removed for GPC analysis. Dibutyl tin oxide (1.72 g) was added and methanol was collected as distillate. The reaction was cooled upon collection of 102.65 g of distillate. Propylene glycol monomethyl ether (143.55 g) was added at 80° C., and the contents of the flask were stirred for 30 minutes at 80° C. and then filtered. Non-volatiles of the product polymer solution were 74.67 wt % as measured with heating at 110° C. for 1 hour. GPC analysis of the product polymer solution using polystyrene standards gave M_{w}=5,151; Mₙ=3,330; and polydispersity index (PDI)=1.55. GPC analysis on the polymer solution before the transcarbamation process (before addition of dibutyl tin oxide catalyst) gave M_{w}=4,391; Mₙ=2,864; and PDI=1.53. The viscosity of the product polymer solution was measured as 35,000 cps at 25° C. and 5,800 cps at 50° C. (using 123Cap2000 Brookfield viscometer at 5 rpm, using spindle no. 6).

### Example 2 of the Invention

### Amphiphilic Carbamate-Functional Copolymer

In a three-neck, round-bottom flask equipped with stirrer, heating mantle, and reflux column including a partial condenser and a reflux condenser connected to a Dean-Stark trap, methyl carbamate (198.61 g) was heated to 140° C. under nitrogen. A mixture of 2-hydroxyethyl methacrylate (382.52 g), lauryl methacrylate (892.55 g, LMA 1214 from BASF Corporation), 2,2′-azobis(2-methylpropionitrile) (127.54 g), and Aromatic 100 solvent (52.71 g) was fed from a monomer tank into the flask over 2.0 hours while maintaining the temperature of the reaction at 140° C. The monomer tank was flushed with Aromatic 100 solvent (52.71 g). Dibutyl tin oxide (2.29 g) was added and methanol was collected as distillate. The reaction was cooled upon collection of 107.1 g of distillate. Propylene glycol monomethyl ether (73.60 g) was added at 80° C. and the contents of the flask were stirred for 30 minutes at 80° C. and then filtered. Non-volatiles of the product polymer solution were 83.74% as measured with heating at 110° C. for 1 hour. GPC analysis of the product polymer solution using polystyrene standards gave M_{w}=5,127; Mₙ=3,327; and PDI=1.54. The viscosity of the product polymer solution was measured as 41,000 cps at 30° C. and 5,740 cps at 50° C. (using 123Cap2000 Brookfield viscometer, at 5 rpm, using spindle no. 6).

### Example 3 of the Invention

### Amphiphilic Carbamate-Functional Copolymer

In a three-neck, round-bottom flask equipped with stirrer, heating mantle, and reflux column including a partial condenser and a reflux condenser connected to a Dean-Stark trap, methyl carbamate (311.84 g) was heated to 140° C. under nitrogen. A mixture of 2-hydroxyethyl methacrylate (587.59 g), heptadecyl methacrylate (587.59 g, C17MA from BASF Corporation), and 2,2′-azobis(2-methylpropionitrile) (106.95 g) was fed from a monomer tank into the flask over 2.5 hours while maintaining the temperature of the reaction at 140° C. The monomer tank was flushed with Aromatic 100 (48.58 g). Dibutyl tin oxide (2.11 g) was added, the contents of the flask were heated to 150°, and methanol was collected as distillate. The contents of the flask were cooled to 80° C., then propylene glycol monomethyl ether (321.1 g) was added and the contents of the flask were stirred for 30 minutes at 80° C., then filtered. Non-volatiles of the product polymer solution were 79.2% as determined with heating at 110° C. for 1 hour. GPC analysis of the product polymer solution using polystyrene standards gave M_{w}=6,656; Mₙ=4,277; and PDI=1.56. The viscosity of the product polymer solution was measured at 36,000 cps at 25° C., 21,648 cps at 30° C. and 5,412 cps at 50° C. (using 123Cap2000 Brookfield viscometer, at 5 rpm, using spindle no. 6).

### Example 4 of the Invention

### Amphiphilic Carbamate-Functional Copolymer

In a three-neck, round-bottom flask equipped with stirrer, heating mantle, and reflux column including a partial condenser and a reflux condenser connected to a Dean-Stark trap, methyl carbamate (311.84 g) was heated to 140° C. under nitrogen. A mixture of 2-hydroxyethyl methacrylate (587.59 g), n-butyl methacrylate (587.59 g), and 2,2′-azobis(2-methylpropionitrile) (106.95 g) was fed from a monomer tank into the flask over 2.5 hours while maintaining the temperature of the reaction at 140° C. The monomer tank was flushed with Aromatic 100 (48.58 g). Dibutyl tin oxide (2.11 g) was added, the contents of the flask were heated to 150°, and methanol was collected as distillate. The viscosity of the reaction mixture increased as methanol was collected. Aromatic 100 (95.20 g) was added to the flask after removing 98.99 g methanol. The reaction mixture was heated to 150° C. until no more methanol was being condensed. The total amount of methanol collected was 120.0 g. The contents of the flask were cooled to 80° C., then propylene glycol monomethyl ether (334.62 g) was added and the contents of the flask were stirred for 30 minutes at 80° C., then filtered. Non-volatiles of the product polymer solution were 76.5% as determined with heating at 110° C. for 1 hour. The viscosity of the product polymer solution was measured at 42,050 cps at 25° C., 21,648 cps at 30° C. and 6,072 cps at 50° C. (using 123Cap2000 Brookfield viscometer, at 5 rpm, using spindle no. 6).

### Example 5 of the Invention

### Coating Composition Prepared with an Amphiphilic Carbamate-Functional Copolymer and Crosslinked Clearcoat Coating Made from the Coating Composition

Example 1 (5.4 g), Aromatic 100 solvent (2.5 g), hexamethoxymethylmelamine formaldehyde resin (2.0 g), and amine-neutralized p-toluenesulfonic acid (0.1 g) were mixed together to form a clearcoat composition. The clearcoat composition was coated onto a phosphate-treated steel panel at 4 mil (101.6 μm) wet thickness using a drawdown bar. After a 5 min wait period, the steel panel was heated in an oven at 141° C. for 45 minutes. The panel was removed from the oven, and cooled down to room temperature. The resulting clearcoat coating had a film thickness of 2 mil (51 μm). The cured coating passed an excess of 300 acetone, ethanol and water rubs and showed high gloss and clarity and excellent scratch resistance.

### Example 6 of the Invention

### Coating Composition Prepared with an Amphiphilic Carbamate-Functional Copolymer and Crosslinked Clearcoat Coating Made from the Coating Composition

Example 3 (10.6 g), Aromatic 100 solvent (5 g), hexamethoxymethylmelamine formaldehyde resin (3.5 g), and amine-neutralized p-toluenesulfonic acid (0.1 g) were mixed together to form a clearcoat composition. The clearcoat composition was coated onto a phosphate-treated steel panel at 4 mil (101.6 μm) wet thickness using a drawdown bar. After a 5 min wait period, the steel panel was heated in an oven at 146° C. for 45 minutes. The panel was removed from the oven, and cooled down to room temperature. The resulting clearcoat coating had a film thickness of 2 mil (51 μm). The cured coating passed an excess of 300 acetone, ethanol and water rubs and showed high gloss and clarity and excellent scratch resistance.

### Example 7 of the Invention

### Coating Composition Prepared with an Amphiphilic Carbamate-Functional Copolymer and Crosslinked Clearcoat Coating Made from the Coating Composition

Example 4 (5.4 g), Aromatic 100 solvent (2.5 g), hexamethoxymethylmelamine formaldehyde resin (2.0 g), and amine-neutralized p-toluenesulfonic acid (0.1 g) were mixed together to form a clearcoat composition. The clearcoat composition was coated onto a phosphate-treated steel panel at 4 mil (101.6 μm) and 8 mil (203.2 μm) wet thickness using a drawdown bar. After a 5 min wait period, the steel panel was heated in an oven at 141° C. for 45 minutes. The panel was removed from the oven, and cooled down to room temperature. The resulting clearcoat coatings had film thicknesses of 2.0 mil (50.8 μm) and 3.8 mil (96.5 μm), respectively. The cured coating passed an excess of 300 acetone, ethanol and water rubs and showed high gloss and clarity and excellent scratch resistance. The film drawn down at 8 mil (203.2 μm) wet thickness showed regions (or domains) of film cracking, most likely due to the higher T_{g} of the polymer of Example 4.

### Testing*—Cracked Domains are Observed

Gloss of the clearcoat coatings of the examples was measured using a Byk-Gardner micro-TRI-gloss meter.

TABLE
GLOSS DATA ON CROSSLINKED FILMS OF
DRAWN DOWN PAINTS

| | Wet Film | Dry Film | | |
|---|---|---|---|---|
| | Thickness | thickness | 60° | 20° |
| Example | (mil) | (mil) | Gloss | Gloss |
| Example 5 | 4.0 | 2.0 | 91.9 | 79.8 |
| Example 5 | 8.0 | 3.8 | 90.0 | 83.5 |
| Example 6 | 4.0 | 2.0 | 91.8 | 86.3 |
| Example 6 | 8.0 | 3.9 | 91.9 | 85.2 |
| Example 7 | 4.0 | 2.0 | 93.4 | 83.2 |
| Example 7 | 8.0 | 3.8 | 85.5* | 77.5* |

*Cracked domains are observed

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

1. A coating composition, comprising
(a) an amphiphilic carbamate-functional copolymer having (i) from about 5 to about 75 weight percent of monomer units with carbamate groups and (ii) from about 16 to about 70 weight percent of monomer units with C₄ to C₂₄ hydrocarbyl groups, with the proviso that the sum of the weight percent of monomer units (i) and the weight percent of monomer units (ii) is at least about 50 weight percent of the copolymer and
(b) an aminoplast curing agent.

2. A coating composition according to claim 1, wherein the monomer units (a)(ii) have C₈ to C₂₄ hydrocarbyl groups.

3. A coating composition according to claim 1, comprising a weight ratio of the carbamate-functional acrylic copolymer to the aminoplast curing agent of from about 50:50 to about 85:15.

4. A coating composition according to claim 1, wherein the carbamate-functional acrylic copolymer is from about 15% by weight to about 85% by weight based on total weight of film-forming materials in the coating composition.

5. A coating composition according to claim 1, wherein the amphiphilic carbamate-functional copolymer has from about 20 to about 65 weight percent of monomer units (a)(i).

6. A coating composition according to claim 1, wherein the amphiphilic carbamate-functional copolymer has from about 25 to about 60 weight percent of monomer units (a)(ii).

7. A coating composition according to claim 1, wherein the sum of the weight percent of monomer units (a)(i) and the weight percent of monomer units (a)(ii) is at least about 70 weight percent of the copolymer.

8. A coating composition according to claim 1, wherein the monomer units (a)(i) are methacrylate monomer units.

9. A coating composition according to claim 1, wherein the monomer units (a)(ii) are methacrylate monomer units.

10. A coating composition according to claim 1, wherein the amphiphilic carbamate-functional copolymer has a viscosity of no more than about 8000 cps at 50° C. as measured according to ASTM D7867 with the copolymer being in a 50 weight percent nonvolatile solution using a solvent mixture with a ratio of 42 wt % Aromatic 100 and 58 wt % dipropylene glycol monomethyl ether.

11. A cured coating obtained by applying a coating composition according to claim 1 to a substrate and curing the applied coating composition.

12. A cured coating according to claim 10, wherein the cured coating is a clearcoat.

13. A cured coating according to claim 11, wherein the clearcoat has a 20° gloss of at least 75.

14. An amphiphilic carbamate-functional copolymer having (a) from about 5 to about 75 weight percent of monomer units with carbamate groups and (b) from about 16 to about 70 weight percent of monomer units with C₄ to C₂₄ hydrocarbyl groups, with the proviso that the sum of the weight percent of monomer units (a) and the weight percent of monomer units (b) is at least about 50 weight percent of the copolymer.

15. An amphiphilic carbamate-functional copolymer according to claim 14, wherein the monomer units (b) have C₈ to C₂₄ hydrocarbyl groups.

16. An amphiphilic carbamate-functional copolymer according to claim 14, having from about 20 to about 65 weight percent of monomer units (a).

17. An amphiphilic carbamate-functional copolymer according to claim 14, having from about 25 to about 60 weight percent of monomer units (b).

18. An amphiphilic carbamate-functional copolymer according to claim 14, wherein the sum of the weight percent of monomer units (a) and the weight percent of monomer units (b) is at least about 70 weight percent of the copolymer.

19. An amphiphilic carbamate-functional copolymer according to claim 14, having from about 40 to about 65 weight percent of monomer units (a).

20. An amphiphilic carbamate-functional copolymer according to claim 14, having a viscosity of no more than about 8000 cps at 50° C. as measured according to ASTM D7867 with the copolymer being in a 50 weight percent nonvolatile solution using a solvent mixture with a ratio of 42 wt % Aromatic 100 and 58 wt % dipropylene glycol monomethyl ether.
